(19) United States
(12) Patent Application Publication
(10) Pub. No.: US 2005/0157710 A1
(43) Pub. Date: Jul. 21, 2005

(54) Data bus system

(75) Inventor: Norbert Rieckmann, Hamburg (DE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Airbus Deutschland GmbH, Hamburg (DE)

(21) Appl. No.: 11/017,497

(22) Filed: Dec. 20, 2004

(30) Foreign Application Priority Data
Dec. 23, 2003 (DE) 103 60 873.7

(51) Int. Cl. H04Q 11/00

(52) U.S. Cl. 370/362

(57) ABSTRACT

In present data bus systems the problem of the “babbling idiot” arises, in other words a situation wherein a terminal arbitrarily starts to transmit although a signal is already present on the bus, thus blocking the bus. According to one exemplary embodiment of the present invention, a determination as to whether the data bus is available is made within the terminal. If it has been determined that the transmitter is transmitting although the data bus is not available, a fault is present and the sender is switched off by means arranged within the terminal.

### BACKGROUND OF THE INVENTION

The present invention relates to data buses in general. In particular, the present invention relates to a method for operating a terminal which receives and transmits data by way of a bus line, a terminal for connection to a bus line, and a data bus system comprising a bus line and a terminal.

In applications such as in the automotive industry or in aircraft construction, these days it is increasingly common to use bus systems instead of complicated cable harness systems. This makes for easier maintainability of the system and also for a reduction both in cabling expenditure and weight. In this, in particular the automotive industry has reached an agreement in relation to a common bus standard, namely the CAN bus system according to DIN ISO 11898. In aircraft construction there are for example the ARINC 629 standard and the MIL-SDT 1553 standard. In particular in applications related to the construction of aircraft it is imperative that the bus system is very robust as far as faults are concerned. At the heart of this issue is the prevention of any breakdown in communication as a result of malfunction of an individual control device or terminal.

In these data bus systems it can indeed happen that a defective device or terminal interferes with the entire bus. The so-called “babbling idiot”, i.e. a device or terminal which continuously writes nonsensical information to the bus, is a typical example of this. In extreme cases this leads to a situation where communication between the other devices/terminals that are connected to the same bus line is no longer possible at all.

Up to now, this has been able to be prevented or brought to an end by external measures only inadequately, in that the individual transmitters have been monitored by external means, and have been switched off from the outside when a “babbling idiot” occurred. This results in increased linking effort and in addition in increased expenditure.

### SUMMARY OF THE INVENTION

According to an exemplary embodiment of the present invention, a method for operating a terminal is provided which receives and transmits data by way of a bus line. The bus line is monitored to determine whether the bus line is busy, i.e. whether data is being transported by way of the bus line. Furthermore, it is determined whether, at the particular time, the corresponding terminal is transmitting data to the bus line. According to the method, the data transmission from the terminal to the bus line is prevented if it has been determined that the terminal is transmitting data to the bus line, and the bus line is busy.

In other words, according to this exemplary embodiment of the present invention any data transmission from the terminal to the bus line may be prevented, or the terminal may be blocked or switched off if the terminal is transmitting although the bus is not available.

It is believed that this makes it possible to switch off or prevent any data transmission from a terminal if said terminal turns out to be a “babbling idiot”, i.e. if this said terminal sends data to the bus line despite the bus line being busy.

According to a further exemplary embodiment of the present invention, a terminal for connection to a bus line is specified in order to receive and transmit data by way of the bus line. The tennis comprises a monitoring circuit for monitoring the bus line in order to determine whether the bus line is busy. Furthermore, the terminal comprises a transmission determination circuit for determining whether the terminal is sending data to the bus line, as well as a transmission prevention circuit for preventing data transmission to the bus line if it has been determined that the terminal is sending data to the bus line although the bus line is busy.

According to this exemplary embodiment of the present invention, a terminal is disclosed which may interrupt data transmission to the bus line entirely without external supervision, i.e. entirely of its own accord, as soon as it has been determined that such data transmission is unjustified. It is believed that thus any faulty behaviour of the transmitter or of the terminal may be detected and prevented at a higher degree of safety than is known from the state of the art.

According to a further exemplary embodiment of the present invention, a data bus system is disclosed which comprises a bus line and a terminal. In this data bus system the terminal comprises a monitoring circuit, a transmission determination circuit and a transmission prevention circuit such that transmit and receive lines of the terminal are monitored and as soon as an unjustified transmission from the terminal or from a transmitter of the terminal is registered, transmission of the data is prevented. Unjustified transmission is for example determined in that the transmitter or the terminal attempts to place data in the data line although said data line is either not available or is busy.

According to another exemplary embodiment of the present invention that both lines of the terminal, i.e. the transmit line and the receive line, are monitored, and when any unjustified transmission on the transmit line is determined, i.e. if the transmitter transmits although the bus is not available, it is determined that a fault has occurred, and the transmitter is switched off.

### BRIEF DESCRIPTION OF THE DRAWINGS

Below, exemplary embodiments of the present invention are described with reference to the accompanying figures.

FIG. 1 is a flow chart of an exemplary embodiment of a method for operating a terminal in a bus system according to the present invention;

FIG. 2 is a simplified block diagram of a first exemplary embodiment of a data bus system comprising a first exemplary embodiment of a terminal according to the present invention; and

FIG. 3 is a simplified block diagram of a second exemplary embodiment of a data bus system comprising a second exemplary embodiment of a terminal according to the present invention.

### DETAILED DESCRIPTION

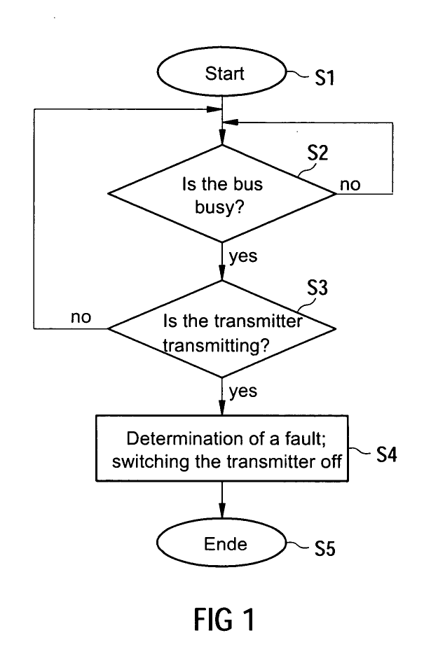

FIG. 1 is a simplified flow chart of an exemplary embodiment of a method for operating a terminal which receives and transmits data by way of a bus line.

As shown in FIG. 1, after the start in step S1, in Step S2 it is determined whether or not the bus, i.e. the bus line, is occupied. If in step S2 it is determined that the bus line is occupied, operation progresses to step S3 in which it is determined whether or not the transmitter of the terminal is transmitting. If in step S3 it is determined that the transmitter is transmitting, operation progresses to step S4 in which subsequently the presence of a fault is determined, and the transmitter is switched off. From step S4 operation progresses to step S5 where operation stops.

If in step S2 it is determined that the bus is not occupied, the process reverses recursively. If in step S3 it is determined that the transmitter is not transmitting, operation reverses recursively to step S2.

The method shown in FIG. 1 can for example be carried out such that a transmit line and a receive line from and to a terminal connected to a bus line are monitored, and any data transmission of the terminal is interrupted if it has been determined that there is data traffic both on the receive line and on the transmit line. Non-identical data traffic on the receive line and on the transmit line means that the data on the transmit line differs from the data on the receive line.

Advantageously, the process steps shown in FIG. 1 are carried out in the respective terminal which is connected to the bus line. In this way, no external supervision is required. This also provides great flexibility to the bus system because for example if new terminals are added, no external control or coordination system needs to be adapted. Furthermore, this increases the robustness of the bus system as far as faults are concerned.

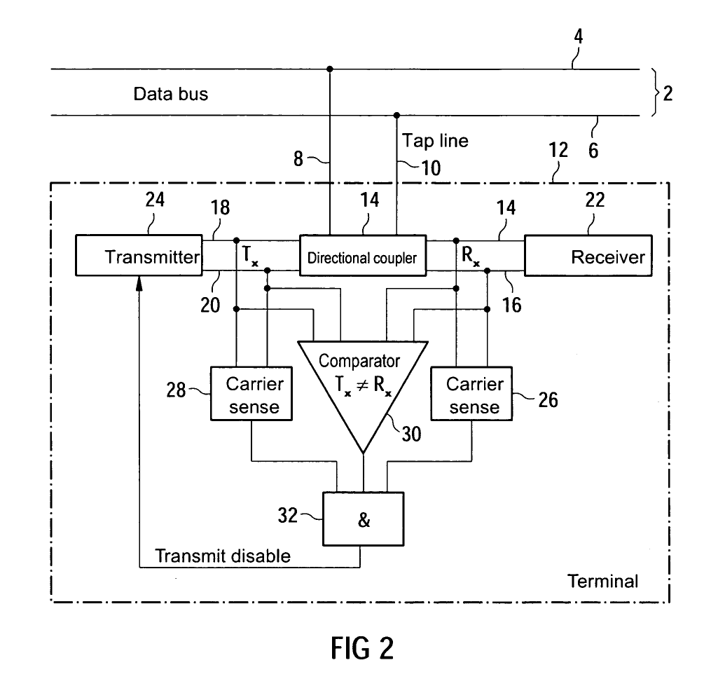

FIG. 2 shows a simplified block diagram of a first exemplary embodiment of a data bus system with a first exemplary embodiment of a terminal according to the present invention.

As shown in FIG. 2, the bus system comprises a data bus 2 with two data lines 4 and 6, each of which is connected to the terminal 12 by way of respective tap lines 8 and 10. In particular, the data lines 4 and 6 are connected to a directional coupler 14 in terminal 12 by way of the tap lines 8 and 10. Apart from the directional coupler 14, the terminal 12 comprises a receiver 22, a transmitter 24, two carrier-sense circuits 26 and 28, a comparator 30, as well as an AND-gate 32, whose output is connected to the transmitter as a “transmit disable”.

The directional coupler 14 is connected to the transmitter 24 by way of transmit lines T_{X} 18 and 20. Furthermore, the directional coupler 14 is connected to the receiver 22 by way of receive lines Rₓ 14 and 16. The receive lines R_{X} 14 and 16 are also input signals for the carrier-sense circuit 26 and the comparator 30. The transmit lines Tₓ 18 and 20 are also input signals for the carrier-sense circuit 28 and the comparator 30. The outputs of the carrier-sense circuits 26 and 28 and of the comparator 30 form the inputs of the AND-gate 32.

The function of the terminal circuit shown in FIG. 2 is as follows: when a signal is present on the data bus 2, the directional coupler 14 distributes said signal to the transmit lines Tₓ and the receive lines Rₓ. T_{X} and R_{X} are monitored by way of signal measuring by the carrier-sense circuits 26 and 28. The carrier-sense circuits 26 and 28 generate an output signal if a signal voltage is correspondingly present on T_{X} or R_{X}. At the same time the signal content of T_{X} and R_{X} is compared by means of the comparator 30. The comparator 30 generates an output signal only if the contents of the input signals, i.e. of T_{X} and R_{X}, are not identical.

If the transmitter 24 during a transmission to the data bus 2 arbitrarily starts data transmission by way of the data bus 2, the following conditions have been met:

1. On the T_{X}-line a signal is detected, whereupon the carrier-sense circuit 28 generates an output signal.

2. On the R_{X}-circuit a signal is detected, whereupon the carrier-sense circuit 26 generates an output signal.

3. The comparator detects that the transmit signal (on T_{X}; i.e. on the lines 18 and 20) is not equal to the receive signal (R_{X}, i.e. on the lines 14 and 16) and subsequently generates an output signal.

These three conditions 1 to 3 are then linked by way of the AND-gate which then by way of “transmit disable” switches the transmitter off. In this way a logic is provided within the terminal 12, which logic suppresses or prevents unjustified transmitting by the transmitter 24. In this way terminal 12 is prevented from developing into a “babbling idiot”.

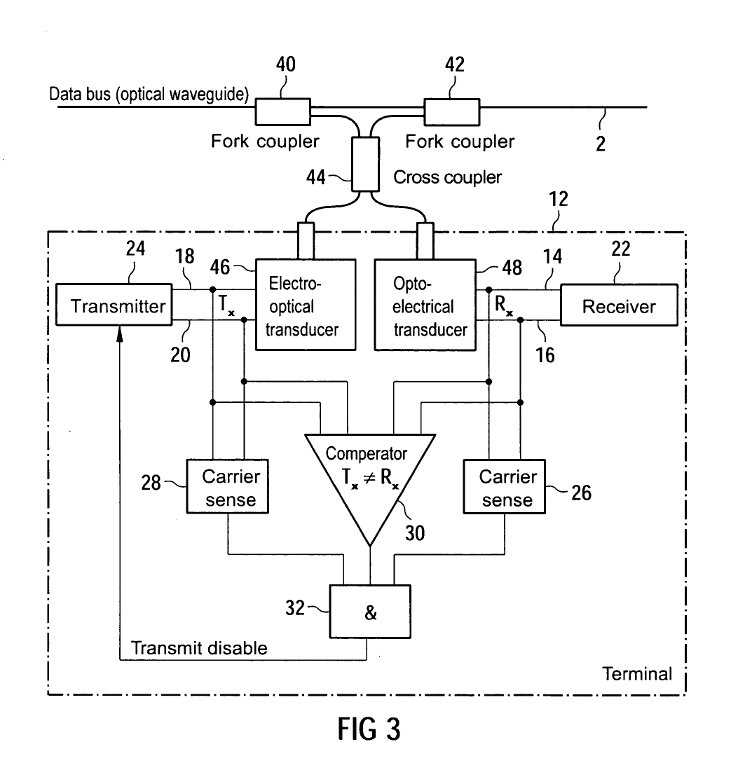

FIG. 3 shows a simplified block diagram of a second embodiment of a data bus system with a second embodiment of a terminal according to the present invention. For identical or corresponding elements, identical reference numbers are used in FIGS. 2 and 3.

The data bus 2 in FIG. 3 is an optical waveguide. Accordingly, the data transmission system shown in FIG. 3 is an optical data transmission system. Since the elements 14, 16, 18, 20, 22, 24, 26, 28, 30 and 32 have already been described in the context of FIG. 2, reference is made to that description. The function of these elements in the exemplary embodiment shown in FIG. 3 corresponds to the function of these elements in the exemplary embodiment shown in FIG. 2.

In a way that is different from FIG. 3, the optical signals from the data bus 2 are decoupled from the optical waveguide by means of fork couplers 40 and 42, and are forwarded by way of a cross coupler 44 to an electro-optical transducer 46 on the transmitter side, and to an opto-electrical transducer 48 on the receiver side. The electro-optical transducers 46 and 48 transduce the electrical signals which are received or transmitted by the terminal into optical signals, which are then coupled into the optical waveguide by way of the cross coupler 44 and the fork couplers 40 and 42. Likewise, the electro-optical transducers 46 and 48 transduce the optical signals which are decoupled from the optical waveguide by the fork couplers 40 and 42 and the cross coupler 44 into electrical signals which form the transmit signal T_{X} on the lines 18 and 20, and the receive signal of R_{X} on the lines 14 and 16.

As already mentioned according to the present invention any faulty behaviour of the transmitter is detected within the terminal with a very high probability, and is also prevented. In this way there is no need to provide any external control or monitoring system which for example switches off a transmitter that changes into a “babbling idiot”. In this way, blocking of the network is prevented.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

1. A method for operating a terminal which receives and sends data via a bus line, comprising the steps of:
monitoring the bus line to determine whether the bus line is busy;
determining whether the terminal is sending data to the bus line; and
preventing data transmission of the terminal to the bus line when it has been determined that the terminal is sending data to the bus line while the bus line is busy;
wherein the terminal prevents data transmission to the bus line of its own accord and free of external supervision.

2. The method of claim 1,
wherein a transmit line and a receive line to and from the terminal are monitored, and data transmission of the terminal is prevented if it has been determined that both on the receive line and on the transmit line the data traffic is different.

3. The method of claim 1,
wherein monitoring the bus line to determine whether the bus line is busy, determining whether the terminal is sending data to the bus line, and preventing data transmission are all carried out within the tennis.

4. The method of claim 1, further comprising the steps:
coupling a transmit signal from a transmit line of the terminal to the bus line such that the transmit signal is not forwarded to a receive line of the terminal; and
decoupling a signal from the bus line to the terminal such that the signal is forwarded to the transmit line and to the receive line of the terminal.

5. The method of claim 1,
wherein the method is applied to one of an electrical data bus and an optical data bus, the one of the electrical data bus and the optical data bus being in an aircraft.

6. A terminal for connection to a bus line, for receiving and sending data via the bus line, comprising:
a monitoring circuit for monitoring the bus line in order to determine whether the bus line is busy;
a transmission determination circuit for determining whether the terminal sends data to the bus line; and
a transmission prevention circuit to prevent data transmission to the bus line when it has been determined that the terminal is sending data to the bus line while the bus line is busy;
wherein the transmission prevention circuit is adapted such that the terminal prevents data transmission to the bus line of its own accord and free of external supervision.

7. The terminal of claim 6,
wherein a transmit line and a receive line to and from the terminal are monitored by means of the monitoring circuit and the transmission determination circuit, and data transmission of the terminal is prevented by means of the transmission prevention circuit if it has been determined that both on the receive line and on the transmit line data traffic is not identical.

8. The terminal of claim 6,
wherein monitoring the bus line to determine whether the bus line is busy, determining whether the terminal is sending data to the bus line, and preventing data transmission are all carried out within the terminal, wherein the monitoring circuit, the transmission determination circuit and the transmission prevention circuit are arranged in the terminal.

9. The terminal of claim 6,
wherein the terminal is connected to the bus line by means of a coupler;
wherein the coupler forwards a transmit signal from a transmit line of the terminal to the bus line without forwarding it to a receive line of the terminal; and
wherein the coupler forwards a signal from the bus line to the receive line and to the transmit line of the terminal.

10. The terminal of claim 6,
wherein the terminal is adapted for connection to at least one of an electrical data bus and an optical data bus; the at least one of the electrical data bus and the optical data bus being in an aircraft.

11. A data bus system comprising a bus line and a terminal which is connected to the bus line in order to receive and send data via the bus line, comprising:
a monitoring circuit for monitoring the bus line to determine whether the bus line is busy;
a transmission determination circuit for determining whether the terminal is sending data to the bus line;
a transmission prevention circuit for preventing data transmission to the bus line when it has been determined that the terminal is sending data to the bus line while the bus line is busy;
wherein the transmission prevention circuit is designed such that the terminal prevents data transmission to the bus line of its own accord and free of external supervision.

12. The data bus system of claim 11,
wherein a transmit line and a receive line to and from the terminal are monitored by means of the monitoring circuit and the transmission determination circuit; and
data transmission of the terminal is prevented by means of the transmission prevention circuit if it has been determined that both on the receive line and on the transmit line the data traffic is different.

13. The data bus system of claim 11,
wherein monitoring the bus line to determine whether the bus line is busy, determining whether the terminal is sending data to the bus line, and preventing data transmission are all carried out within the terminal, wherein the monitoring circuit, the transmission determination circuit and the transmission prevention circuit are arranged in the terminal.

14. The data bus system of claim 11,
wherein the terminal is connected to the bus line by means of a coupler;
wherein the coupler forwards a transmit signal from a transmit line of the terminal to the bus line without forwarding it to a receive line of the terminal; and
wherein the coupler forwards a signal from the bus line to the receive line and to the transmit line of the terminal.

15. The data bus system of claim 11,
wherein the data bus system is one of an electrical data bus and an optical data bus, wherein the at least one of the electrical data bus and the optical data bus are arranged in an aircraft.
